(19) United States
(12) Patent Application Publication
(10) Pub. No.: US 2008/0228666 A1
(43) Pub. Date: Sep. 18, 2008

(54) SYSTEMS AND METHODS OF MEASURING INVESTMENT PERFORMANCE

(75) Inventors: Matthew D. Hutcheson, Tigard, OR (US); Thomas L. Peterson, Tualatin, OR (US); Daniel S. Peterson, Tualatin, OR (US)

Correspondence Address: KOLISCH HARTWELL, P.C., 520 SW YAMHILL STREET, Suite 200, PORTLAND, OR, 97204, US

(73) Assignee: G Fiduciary, LLC, Tualatin, OR (US)

(21) Appl. No.: 12/050,056

(22) Filed: Mar. 17, 2008

Related U.S. Application Data
(60) Provisional application No. 60/895,336, filed on Mar. 16, 2007.
(60) Provisional application No. 60/913,020, filed on Apr. 20, 2007.

(51) Int. Cl. G06Q 40/00; G06F 17/10

(52) U.S. Cl. 705/36 R

(57) ABSTRACT

Systems for measuring the performance of an investment portfolio over a specific time period include a report having indicia of a portfolio index value, the portfolio index value representing a hypothetical return on investment of a hypothetical portfolio for the specific time period calculated as a function of actual timing and actual amounts of actual deposits to and actual withdrawals from the investment portfolio during the specific time period and one or more benchmarks so that a recipient of the report can compare the hypothetical return on investment to an actual return on investment of the investment portfolio.

### RELATED APPLICATIONS

This application is based upon and claims priority under 35 U.S.C. § 119(e) to U.S. Provisional Application Ser. No. 60/895,336, entitled “METHODS OF MEASURING INVESTMENT PERFORMANCE,” filed on Mar. 16, 2007, and U.S. Provisional Application Ser. No. 60/913,020, entitled “METHODS OF MEASURING INVESTMENT PERFORMANCE,” filed on Apr. 20, 2007, the contents of which are hereby incorporated by reference for all purposes.

### BACKGROUND

The present application relates to systems and methods of measuring investment performance.

### BRIEF DESCRIPTION OF THE DRAWINGS

FIG. 1 is a schematic representation of a report including indicia of a portfolio index value according to the present disclosure.

### DETAILED DESCRIPTION

A portfolio index value according to the present disclosure is an objective measure against which the financial performance of an investment portfolio of an individual investment plan (“plan”) (e.g., but not limited to, a pension plan or a 401(k) plan) or of an individual participant account within a plan (“participant account”) can be measured. As used herein, an “investment portfolio” may refer to an overall portfolio of a plan or to an individual portfolio of a participant account, and may (but is neither required to nor limited to) include securities, stocks, bonds, mutual funds, cash, money market funds, etc.

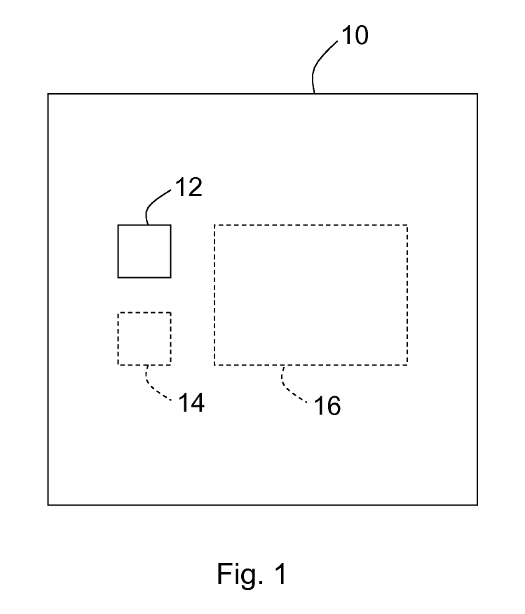

The portfolio index value may represent a hypothetical return on investment for an investment portfolio that can be compared to an actual return on investment for the investment portfolio, for example in a report 10, as schematically illustrated in FIG. 1. Report 10 may therefore include indicia 12 of the portfolio value index. Report 10 may also (but is not required to) include indicia 14 of an actual return on investment for the investment portfolio. Report 10 may further (but is not required to) include additional indicia 16 of various information related to the investment portfolio. Report 10 may, for example, be a monthly statement, a quarterly statement, an annual statement, or any other report including information related to the investment portfolio. Report 10 may be in paper form, or it may be in electronic form, for example, available via email or on a Web site. In general, report 10 represents any mechanism for conveying information including the portfolio value index.

The portfolio index value for an investment portfolio is calculated based upon the actual amounts and timing of deposits (and withdrawals, if any) for the investment portfolio in question. In other words, the calculation applies a consistent methodology to a varying stream of deposits (and withdrawals) relating to an investment portfolio of a plan or an account to derive the portfolio index value. The portfolio index value may represent a hypothetical return on investment, for example, expressed as a hypothetical percentage annualized return on investment. Additionally or alternatively, the hypothetical return on investment may be expressed as a numerical amount of money, for example, expressed as a hypothetical portfolio value as of a specific date. Additionally or alternatively, the portfolio index value may be expressed as a cost (or advantage) of the actual financial performance when compared to a hypothetical return on investment, for example, expressed either as a percentage of cost/advantage or as a numerical amount of money (whether positive or negative depending on if there was a cost or an advantage to the actual financial performance).

The calculation of a portfolio index value enables plan fiduciaries and participants (as well as regulators) to compare actual investment returns realized by specific portfolios with those of a standard, or model, portfolio. This standard portfolio may also be described as a benchmark or as a hypothetical portfolio. Plan sponsors and fiduciaries, participants, and regulators are thus better able to make informed decisions by having access to information regarding the investment returns they would have realized had they invested in a standard portfolio. The standard portfolio may be defined as a portfolio that has been recognized by economists, investment professionals, and the U.S. Courts as being prudent and efficient. Accordingly, plan sponsors and fiduciaries, participants, and regulators may easily determine whether a specific investment portfolio is measuring up to prudent and efficient investing. Stated differently, the portfolio index value may reflect what a plan or participant could or should have received as an investment return had the portfolio's assets been invested in a prudent portfolio. That is, the calculation of the portfolio index value for a plan or a participant may represent the prudent return.

The value of the portfolio index value may be realized by several groups:

(a) Individual participants and their beneficiaries are better able to make decisions regarding the sources and security of their retirement income as they compare the actual performance of their retirement accounts to an objective standard.

(b) Plan sponsors (“sponsors”) are better able to make decisions regarding the retirement plans that they sponsor for the benefit of their employees.

(c) Public agencies, such as the Department of Labor, are better able to identify potential sources of abuse of retirement plan assets and can more quickly take remedial steps for the benefit of participants.

(d) Plan fiduciaries are better able to compare the investment performance of the plans they administer.

(e) Prospective employees are better able to judge the value of the retirement plan offered by a particular employer.

(f) The overall costs of pension plans in general are driven down as clear, concise, reliable and consistent information is made available to plan sponsors and participants, resulting in more savings being retained by the participants.

(g) The public at large is benefited as private pension plans are better able to shoulder the impending burden of large numbers of retirees drawing upon the assets of the Social Security trust fund due to the improved investment performance resulting from competition.

(h) Political leaders have a tool to hold accountable the providers of financial services.

(i) The time period over which the performance of plan or participant investment returns is calculated can vary according to what is deemed most desirable or useful by plan sponsors, fiduciaries, participants or regulators.

Other benefits may also exist.

The portfolio index value may be made available to the government for use as the standard for measuring performance for all 401(k) plan (or other investment or pension plans) participants. In this way, every individual account holder would know precisely the cost of administering the plan and how his/her returns measure against the market standard, represented by the 60:40 index described below.

The portfolio index value may be calculated using the following elements for a specific plan or account:
(a) the dates, beginning with the first deposit into the plan or account, and ending on the last date in the period for which the portfolio index value is calculated, i.e., T₀ through Tₙ;
(b) the beginning dollar value of the plan or account (V₀);
(c) the dollar amounts of each deposit into the plan or account on each date (D₀ through Dₙ);
(d) the number of days between each successive non-zero deposit (≡Δab, which denotes the number days calculated as the date value of non-zero deposit “b” minus the date value of the immediately preceding non-zero deposit “a”;
(e) the daily portfolio index value factor (≡Glf, equal to 1.5% per year (or other predetermined percentage), divided by 365 days per year, or 0.00004109589);
(f) the numerical value of the S&P 500 Index (or other appropriate index) (at the close of the market) on each date during the relevant period (≡SP₀ through SPₙ);
(g) the numerical value of the Lehman Brothers Aggregate Bond Index (or other appropriate index) (at the close of the market) on each date during the relevant period (≡LB₀ through LBₙ);
(h) the hypothetical purchase amount on the date of each deposit (≡P₀ through Pₙ);
(i) the hypothetical purchase of assets (Pₓ) associated with each deposit (Dₓ) is equal to Dₓ−(Δab*Glf*V₍ₓ₋₁₎)]. (The derivation of V₍ₓ₋₁₎ is outlined in paragraph (q), below);
(j) each hypothetical purchase of assets (Pₓ) is comprised of the hypothetical purchase of S&P 500 Index (or other appropriate index) Units and the hypothetical purchase of Lehman Aggregate Bond Index (or other appropriate index) Units in a 60:40 ratio, such that 60% of Dₓ is used to purchase SP₍ₓ₋₁₎, and 40% of Dₓ is used to purchase LB₍ₓ₋₁₎;
(k) the number of units of the S&P 500 Index (or other appropriate index) hypothetically purchased on each Deposit date (≡USPₓ) is equal to (Pₓ*0.60)/SP₍ₓ₋₁₎);
(l) the number of units of the Lehman Brothers Aggregate Bond Index (or other appropriate index) hypothetically purchased on each deposit date (≡ULBₓ) is equal to (Dₓ*0.40)/LB₍ₓ₋₁₎);
(m) the cumulative number of units of the S&P 500 Index (or other appropriate index) hypothetically purchased by the plan or participant from the beginning date to the last date in the relevant period is denoted (SUSPₙ≡USP₀+USP₁+ . . . USPₙ);
(n) the value of the units of the S&P 500 Index (or other appropriate index) hypothetically owned by the plan or participant on any date, ₓ, is denoted VSUSPXₓ≡SUSPₓ*SPₓ;
(o) The cumulative number of units of the Lehman Aggregate Bond Index (or other appropriate index) hypothetically purchased by the plan or participant from the beginning date to the last date in the relevant period is denoted (SULBₙ≡ULB₀+ULB₁+ . . . ULBₙ)
(p) the value of the units of the Lehman Aggregate Bond Index (or other appropriate index) hypothetically owned by the plan or participant on any date, ₓ, is denoted VSULBₓ≡SULBₓ*LBₓ;
(q) the total value of the hypothetical portfolio of the plan or participant on any date Vₓ≡VSULBₓ+VSUSPₓ;
(r) the amount of each deposit into the plan or account is equal to the actual amount of cash deposited into the plan or account; and
(s) the date of each deposit is the date on which the actual purchase of securities would normally occur, not the (usually earlier) date on which funds are transferred to the plan or account.

As mentioned, the portfolio index value may be expressed as a hypothetical percentage annualized return on investment. Such a portfolio index value may be calculated as follows:
(a) The daily internal rate of return (“DIRR”) is calculated for the following sequence: IRR(−Vₒ, −D₁, −D₂, . . . −Dₙ, +Vₙ) with zero placeholders inserted for every day in the sequence on which no deposit was made. In other words, if the beginning balance was $10, and a $1 deposit was made on every third day for a week, then the sequence would appear (−$10₀, −$0₁, −$0₂, −$1₃, −$0₄, −$0₅, −$1₆, −$0₇+V₇), and the calculation of the DIRR would be the determination of the daily discount rate (“r”) that makes the sum of the following sequence equal to zero: [−($10₀)−($0₁/(1+r))−($0₂/(1+r)̂²)−($1₃/(1+r)̂³)−($0₄/(1+r)̂⁴)−($0₅/(1+r)̂⁵)−($1₆/(1+r)̂⁶)−($0₇/(1+r)̂⁷)+(V₇/(1+r)̂⁷)].
(b) The annualized internal rate of return for the sequence would be derived as [(1+DIRR)̂³⁶⁵−1].
(c) The portfolio index value expressed in terms of a hypothetical percentage annualized return on investment equals the annualized internal rate of return derived in (b), above.

### Extensions of Basic Methodology:

The portfolio index value can apply to a wider range of fact situations than those described above. Most significantly, the portfolio index value may be calculated accurately and consistently in circumstances where there are withdrawals from the plan or account as well as deposits. The withdrawals would simply be reflected as a “positive” element in the sequence used to calculate the DIRR, but the remainder of the methodology would remain the same. However, when there are both negative and positive elements in the sequence used to calculate the DIRR, there is a probability that the solution for “r” will not be unique. When that occurs, the solution for “r” that most closely matches the solution for “r” derived from a sequence that ignores the withdrawals will be used.

Additionally, in a situation where the initial sum (Vₒ) is moved into the plan and the 1.5%/365 days' fee to be deducted from the ensuing contribution is more than the ensuing contribution itself (e.g., if a $10 million plan were invested, and the “next” contribution was $100), the calculation of the portfolio index value for that particular plan may need to be modified. In such situations, the portfolio index value may be calculated based upon the fee being calculated from the first (series of) sums received (in ensuing contributions) until the fee amount is paid in full, and the remainder of contributions would go into the principal of the plan and invested in the standard 60:40 (SP:LB) ratio.

As mentioned, the portfolio index value may also be expressed in terms of a dollar measure of performance. Determination of the portfolio index value in terms of a dollar measure of performance requires the calculation of a value of the hypothetical portfolio at the end of the measurement period (≡Vₙ). That ending value, Vₙ, can then be compared with the actual value of the plan or participant account investment portfolio as of the same date in order to determine the excess dollar cost of investing in a manner that does not meet the standard, or model, portfolio. Since the starting values of the portfolios and the actual deposits in each instance would be identical, the comparison of the derived Vₙ and the actual value of the portfolio gives the plan sponsor, fiduciary, participant, regulator, or other interested party, an accurate measure of the excess dollar cost of the plan or participant account vis-à-vis the portfolio index value over the relevant period. The excess cost can be annualized if deemed necessary or desirable by simply taking the total costs over the relevant period, dividing by the number of days in the period, and multiplying by 365.

That total excess costs of not meeting the portfolio index value over the relevant period can then be projected over a time period equal to the average number of years to retirement (for a plan) or the anticipated number of years to retirement (for an individual participant) in order to determine the total loss in anticipated savings as a result of not meeting the portfolio index value. The assumed rate at which the cumulative excess costs of not meeting the portfolio index value should be compounded would be equal to the historical performance of the standard portfolio (e.g., a 60:40 weighted average portfolio of S&P 500 Index and Lehman Aggregate Bond Index Funds over the past ten or more years, less the annual Glf of 1.5% (or other appropriate predetermined administration cost) per year, which takes into account the reasonable costs of administering a 401(k), or other pension or retirement, or investment plan (e.g., costs of managing the assets and other costs) including, but not limited to, record-keeping, custodial services, audits, federal reporting, reporting to plan managers and participants, enrollment costs, investor education resources, trustee fees, fiduciary insurance, bonds, professional fiduciary fees, etc.). By compounding the excess dollar costs in such a manner, it is possible to determine the total loss in savings at retirement as a result of not meeting the portfolio index value. With that information, it is a simple matter to determine the loss in monthly income following retirement, by calculating the monthly payments of an annuity purchased at the anticipated retirement date that pays out over the remaining life expectancy of an average person at retirement age, published by the US Census Bureau.

The methodology described in the preceding two paragraphs translates the cost of not meeting the portfolio index value into: (a) the current loss in portfolio value; (b) the future loss in retirement portfolio value at the age of retirement; and (c) the future loss in periodic income that would otherwise be available to the participant.

Variations on the methodologies and calculations described above may also be used.

The primary portfolio index value methodology for calculating a standard annualized investment return on a retirement portfolio is based on the work of economists and other researchers—and confirmed by U.S. Federal Courts—regarding an efficient, prudent, long-term investment strategy. Specifically, the seminal work of William Sharpe regarding the prudence and efficiency of a widely-diversified investment portfolio comprised of 60% stocks and 40% bonds, may be used as the basis for the calculation of the portfolio index value for particular plans and participant accounts. However, there may be other standards more appropriate to situations other than a retirement portfolio. There may also be investment portfolios more appropriate to the circumstances of the plan and/or participants—for example in relation to non-US-based firms. In those circumstances, the use of (0.6*SPₓ) and (0.4*LBₓ) could be replaced by the proper relative weighting of indexes other than the S&P 500 Index and the Lehman Brothers Aggregate Bond Index. Similarly, the variable that is used to reflect the daily overhead cost of the Plan or Account, “GIf,” could be replaced with another factor that more accurately reflects the cost of administering the investment program appropriate to the circumstances. In addition, in the event that the S&P 500 Index and/or the Lehman Brothers Aggregate Bond Fund Index are no longer calculated or published, other measures of the performance of a broadly diversified portfolio of similar securities could be used with nearly equal results. Although the portfolio index value can be calculated for any period of time during which the SP and LB indexes have been (or will be) published and deposit information is available, it is anticipated that the portfolio index value will be calculated for each plan and participant over the same periods as are currently being reported in connection with existing plans and accounts in order to be most useful as a standard of comparison.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

Inventions embodied in various combinations and subcombinations of features, functions, elements, properties, steps and/or methods may be claimed through presentation of new claims in a related application. Such new claims, whether they are directed to a different invention or directed to the same invention, whether different, broader, narrower, or equal in scope to the original claims, are also regarded as included within the subject matter of the present disclosure.

1. A system for measuring the performance of an investment portfolio over a specific time period, comprising:
a report including indicia of a portfolio index value, the portfolio index value representing a hypothetical return on investment of a hypothetical portfolio for the specific time period calculated as a function of actual timing and actual amounts of actual deposits to and actual withdrawals from the investment portfolio during the specific time period and one or more benchmarks so that a recipient of the report can compare the hypothetical return on investment to an actual return on investment of the investment portfolio.

2. The system of claim 1, wherein the investment portfolio is a portfolio of an investment plan having individual participant accounts.

3. The system of claim 1, wherein the investment portfolio is a portfolio of an individual participant account within an investment plan.

4. The system of claim 1, wherein the one or more benchmarks includes a stock index and a bond index.

5. The system of claim 4, wherein the one or more benchmarks is a function of a 60 to 40 ratio of the stock index to the bond index.

6. The system of claim 5, wherein the stock index is the S&P 500 Index and the bond index is the Lehman Brothers Aggregate Bond Index.

7. The system of claim 1, wherein the portfolio index value is further a function of a predetermined portfolio administration cost.

8. The system of claim 1, wherein the portfolio index value is further a function of the deposits minus the predetermined portfolio administration cost.

9. The system of claim 1, wherein the portfolio index value is equal to [(1+DIRR)³⁶⁵−1];
wherein DIRR is equal to r when
$$[ - {V}_{0} + {\sum }_{0}^{N} ( - \frac{{D}_{n}}{{( 1 + r )}^{n}} ) + {V}_{N} ]$$
is equal to zero;
wherein N represents a total number of days in the specific time period, Dₙ represents a positive deposit or negative withdrawal on a specific day, n, within the specific time period, V₀ represents a total value of the investment portfolio at the beginning of the specific time period, and V_{N} equals a total value of the hypothetical portfolio at the end of the specific time period, the hypothetical portfolio including units of the one or more benchmarks hypothetically purchased using the deposits Dₙ.

10. The system of claim 9, wherein V_{N} equals VSULB_{N}+VSUSP_{N};
wherein VSULB_{N} represents the value of units of a bond index hypothetically held by the hypothetical portfolio, and VSUSP_{N} represents the value of units of a stock index hypothetically held by the hypothetical portfolio, wherein the number of units of the bond index and the number of unit of the stock index are based on a predetermined methodology.

11. The system of claim 10, wherein the predetermined methodology is based on a nationally recognized prudent retirement investment strategy.

12. A method of measuring the performance of an investment portfolio over specific time period, comprising:
calculating a portfolio index value that represents a hypothetical return on investment of a hypothetical portfolio for the specific time period, the portfolio index value a function of actual timing and actual amounts of actual deposits to and actual withdrawals from the investment portfolio during the specific time period and one or more benchmarks; and
publishing the portfolio index value in a report so that a recipient of the report can compare the hypothetical return on investment to an actual return on investment of the investment portfolio.

13. The method of claim 12, wherein the investment portfolio is a portfolio of an investment plan having individual participant accounts.

14. The method of claim 12, wherein the investment portfolio is a portfolio of an individual participant account within an investment plan.

15. The method of claim 12, wherein the one or more benchmarks includes a stock index and a bond index.

16. The method of claim 15, wherein the one or more benchmarks is a function of a 60 to 40 ratio of the stock index to the bond index.

17. The method of claim 16, wherein the stock index is the S&P 500 Index and the bond index is the Lehman Brothers Aggregate Bond Index.

18. The method of claim 12, wherein the portfolio index value is further a function of a predetermined portfolio administration cost.

19. The method of claim 12, wherein the portfolio index value is further a function of the actual deposits minus the predetermined portfolio administration cost.

20. The method of claim 12, wherein the portfolio index value is equal to [(1+DIRR)³⁶⁵−1];
wherein DIRR is equal to r when
$$[ - {V}_{0} + {\sum }_{0}^{N} ( - \frac{{D}_{n}}{{( 1 + r )}^{n}} ) + {V}_{N} ]$$
is equal to zero;
wherein N represents a total number of days in the specific time period, Dₙ represents a positive deposit or negative withdrawal on a specific day, n, within the specific time period, V₀ represents a total value of the hypothetical portfolio at the beginning of the specific time period, and V_{N} equals a total value of the hypothetical portfolio at the end of the specific time period, the hypothetical portfolio including units of the one or more benchmarks hypothetically purchased using the deposits Dₙ.

21. The method of claim 20, wherein V_{N} equals VSULB_{N}+VSUSP_{N};
wherein VSULB_{N} represents the value of units of a bond index hypothetically held by the hypothetical portfolio, and VSUSP_{N} represents the value of units of a stock index hypothetically held by the hypothetical portfolio, wherein the number of units of the bond index and the number of unit of the stock index are based on a predetermined methodology.

22. The method of claim 21, wherein the predetermined methodology is based on a nationally recognized prudent retirement investment strategy.
